(19) United States
(12) Patent Application Publication
(10) Pub. No.: US 2005/0145096 A1
(43) Pub. Date: Jul. 7, 2005

(54) Stringed instrument string and fret board cleaner

(76) Inventor: Craig Thomas Kalousek, Ravenden Springs, AR (US)

Correspondence Address: CRAIG THOMAS KALOUSEK, 190 HAAS CEMETARY ROAD, RAVENDEN SPRINGS, AR, 72460, US

(21) Appl. No.: 11/010,801

(22) Filed: Dec. 13, 2004

Related U.S. Application Data
(60) Provisional application No. 60/531,525, filed on Dec. 18, 2003.

(51) Int. Cl. G10D 3/06; G10G 1/00

(52) U.S. Cl. 84/453

(57) ABSTRACT

The present invention is used to clean the strings, frets and fret board on stringed musical hand held instruments while the strings are left on the instrument. This allows the user to quickly and efficiently clean the above parts of the instrument between string changes reducing string changes and maintaining tonal quality.

### CROSS-REFERENCE TO RELATED APPLICATIONS

I am aware of a similar device in partial application only: 611,137 May 17th 1984. Joseph P. Gentile, Jr. discloses a cleaning device which is adapted to clean strings of stringed instruments only.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISK APPENDIX

“Not Applicable”

### BACKGROUND OF THE INVENTION

This invention relates to the cleaning of stringed instruments strings and fret boards, such as, but not limited to guitars, basses, etc.

Stringed instrument users spend many hours playing their instrument. The playing of

Stringed instrument users spend many hours playing their instrument. The playing of stringed instruments is very intense, and requires a lot of time holding and using the instrument. The areas of the instrument that require the most maintenance are the strings and fret board. It is very desirable to keep these areas as clean as possible, as much as possible. It is an ultimate goal to keep the instrument in prime playing condition. Time is the factor between how many times a person will clean their stringed instruments strings and fret board. It is usually done between string changes or in an unsatisfactory way while the strings are on the instrument. A method to do it very quick and efficient while the strings are in place on the instrument is desirable.

The need therefore exists for a quick and efficient way to clean the strings of a stringed instrument and fret board while the strings are on the instrument. Many string and fret board cleaners and conditioners are available but it is up to the user to come up with an application technique which is very limited and inefficient. During the playing of stringed instruments, dirt, oils and grime, are deposited from fingers touching the strings, frets and fret board. These deposits cause the strings to tarnish, rust and deaden the brightness and tonality. It also causes buildup of dirt and grime on the fret board wood and frets. This will cause the fret board “action” to be sticky and slow to finger movement while playing. It will cause premature deterioration and pitting of fret board surface wood and the tarnishing of the frets.

### BRIEF SUMMARY OF THE INVENTION

The “String and fret board cleaning device” will allow the stringed instrument player, to quickly and efficiently clean the strings of a guitar or similar instrument and its fret board while the strings are still on the instrument. It will allow the user to use cleaners and conditioners more sparingly with satisfactory results. It will improve the life and tonality of the strings for a much longer period of time avoiding costly string replacement. It will promote slicker faster “action” or sliding movement of the fingers while playing. The fret board will be free of a dirt build up over the natural wood or varnish depending on the fret board finish. Regular cleaning of the fret board will make a guitar last many more years and retain a higher value. A better understanding drawings.

### BRIEF DESCRIPTION OF THE SEVERAL VIEWS OF THE DRAWING

FIG. 1 This is a sectional view of a guitar neck showing all parts of the neck and the cleaning device. The device is installed and ready to use as shown.

1a. Neck

1b. Strings

1c. Fret board

1d. Frets

1e. “String and fret board cleaner” installed between strings and fret board on the sectional view of the guitar neck.

FIG. 2 This is a sectional cut away of a guitar neck viewed from the angle of the section. It shows the device under the strings between the strings and fret board.

2a. This circle represents 6 guitar strings.

2b. The side view of the body of the cleaning device

2c. The sectional view of the fret board surface

2d. The sectional view of the neck of the instrument

2e. The side view of the string cleaning throw away pad, adjacent to the scrubbing/receiving material which is permanently attached to the body.

2f. The side view of the fret board cleaning peel off throw away pad, adjacent to the scrubbing/receiving material which is permanently attached.

FIG. 3 The whole unit is then removed and flipped over to the same side as was cleaning the underside of strings. It is placed on top of the strings and moved up down with slight pressure to remove debris off top and sides of strings.

3a. Fret board cleaning pad removed.

3b. String cleaning pad

3c. Strings

FIG. 4 Body of the device with string cleaning side up showing permanently attached string

FIG. 4 Body of the device with string cleaning side up showing permanently attached string solution receiving/scrubbing strip.

FIG. 5 Body of device showing fret board cleaning side up showing permanently attached fret board solution receiving/scrubbing strip.

FIG. 6 cotton/felt sticky back cleaning pad.

FIG. 7 Side view of the device with all parts attached.

7a. Rectangular body.

7b. String scrubbing/receiving strip.

7c. String cotton/felt sticky back cleaning pad.

7d. Fret board cotton/felt sticky back cleaning pad.

7e. Fret board scrubbing/receiving strip.

FIG. 8 End view of the device with all parts attached.

8a. String scrubbing/receiving strip.

8b. Body

8c. Fret board scrubbing/receiving strip

8d. Cotton/felt sticky back pad

### DETAILED DESCRIPTION OF THE INVENTION

It is an objective of my invention to provide:

A method of cleaning the strings, frets and fret board of stringed musical instruments, such as guitars, basses, acoustic instruments and the like, with the strings left on the instrument.

A device that is easy to manufacture and inexpensive.

A device that is less time consuming to use and easy to install.

A method of having cleaning pads that can be used to clean and discarded after cleaning of the strings and fret board.

A method of efficient use of cleaners and conditioners.

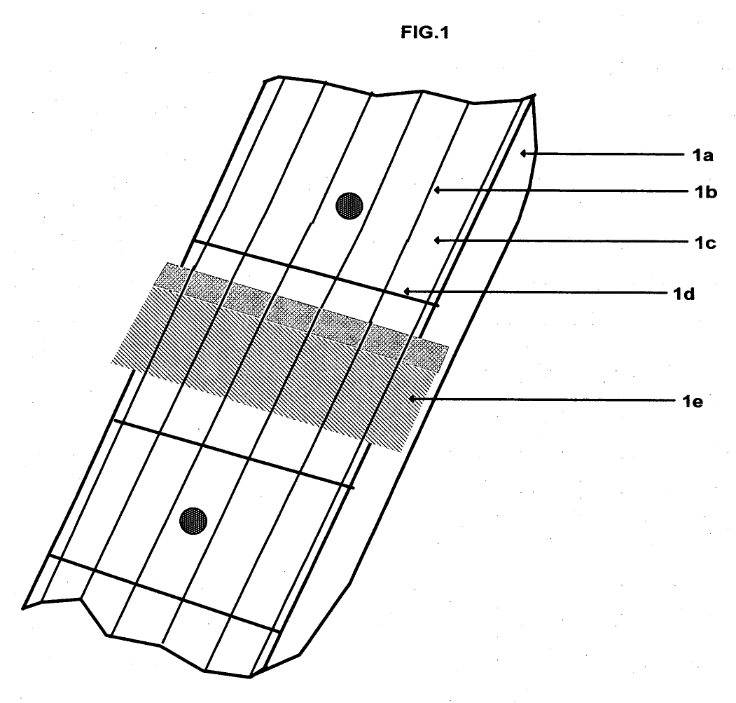

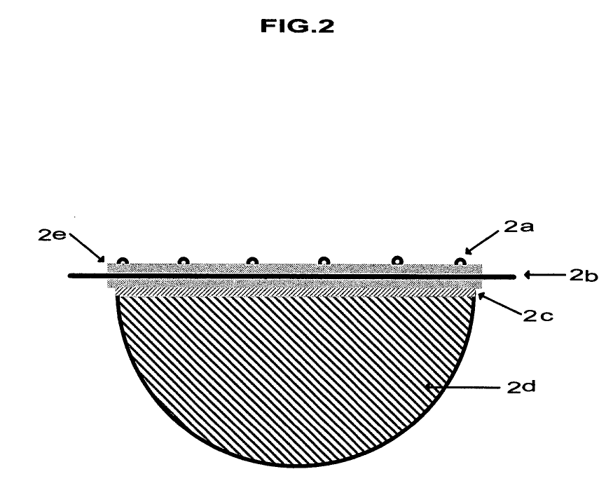

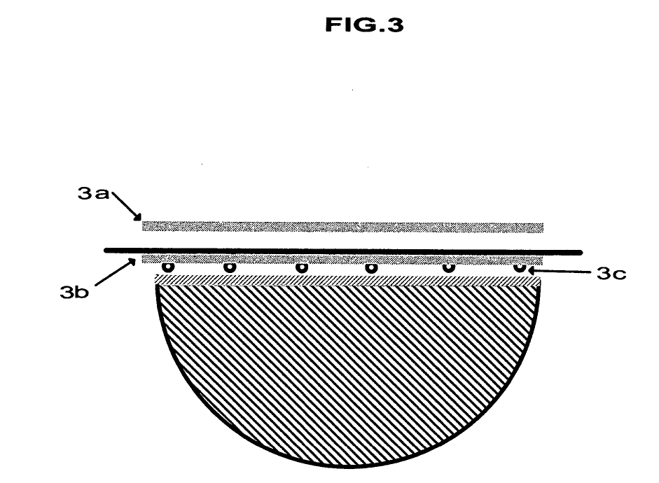

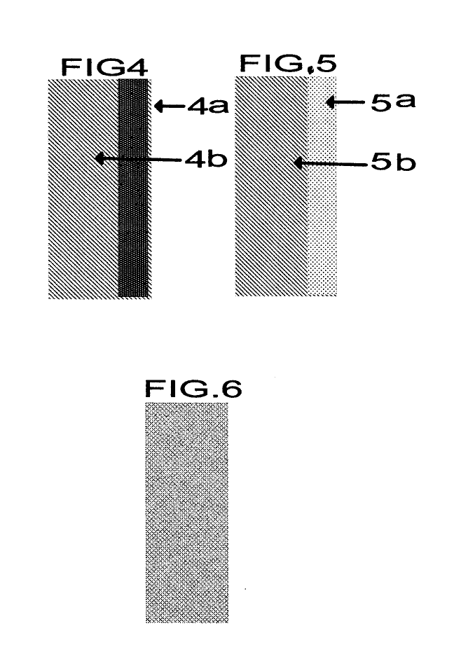

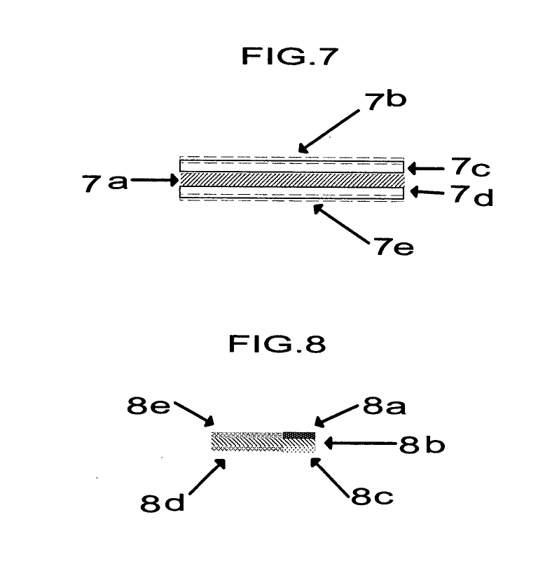

“The Stringed Instrument String and Fret board Cleaner”, as seen in FIG. 1 is a handheld device that will clean the top and bottom of, but not limited to, guitar and bass strings and will simultaneously wipe debris from the frets and fret board, while the strings are still on the instrument. It does this process quickly and easily. The described body of the device as seen in FIG. 1 and is also shown in FIGS. 4, 5, 7a, 8b is made of thin flexible Plastic, or a similar material, cut into a rectangle 2″ wide by 5″ long 1/16″ thick. It will fit between the bottom of guitar strings, on a guitar, and rests on top of the fret board as seen in FIGS. 1, 2. On each side, along the 5″ edge and permanently connected to said device, is a thin strip of receiving and/or scrubbing material which receives the string and/or fret board cleaner FIGS. 4a, 5a. These two strips are 5″ long and ½″ wide. The string cleaning side FIG. 4a, is a low nap dense hard plastic bristle material similar to the rough side of Velcro R. The material is saturated with cleaner. As the device is moved up and down the strings, the cleaner is absorbed into the string windings while the bristle material scrubs grime from the strings, which is then picked up by the cleaning pad. The other side of the device which is touching the fret board is a medium nap soft plastic fiber material similar to the soft side of Velcro R. The fret board cleaning solution is placed directly on the fret board wood surface in several places up the neck across the fret board surface. As the device is moved up and down for string cleaning the absorbing strip is picking up the cleaner and scrubbing the frets and fret board, loosening dirt and grime. The cotton pad absorbs the loosened dirt and grime from the frets and fret board. The remainder of the two sides of said device are covered with a sticky back cotton or felt pad with low nap FIG. 6, which has a peel away back that sticks to the remainder of the rectangular body FIGS. 4b, 5b. This is the dirt and grime remover part of the device. It lifts the grime from the string windings, frets and fret board, as it is dissolved by cleaner. The device is placed between the strings and fret board FIGS. 1, 2 moved up and down the neck of the stringed instrument with a slight back and forth motion. It is then removed and moved up and down on the top of the instruments strings FIG. 3, on the string cleaning side, to clean the windings on the top and sides of the strings. When dirty buildup is removed, the cotton pads on both sides FIGS. 7c, 7d or either side are peeled off and discarded FIG. 3a. After many uses, the permanently attached receiving and scrubbing material on both sides FIGS. 4a, 5a can be cleaned with any mild soap product and a small scrubbing brush under Certain modifications may be made to the above device to further enhance the cleaning or longevity of the device, as well as manufacturing cost, without departing from the primary scope of the invention. The disclosed embodiment of the device may be modified in size or thickness to accommodate certain other stringed instruments. The description and drawings of the device are not to scale and therefore are illustrative and not limiting the device to a certain size, shape or material in which it is manufactured.

1. A cleaning device for cleaning strings, frets and fret board on stringed instruments such as guitars and the like, while the strings are still on the instrument comprising of:
a) an elongated planer flexible body thin enough to be placed between fret board and strings and long enough to extend outward on each side of the neck away from the strings to enable the user to grasp the ends.
b) a fluid receiving/scrubbing strip of material on the outer planer edge of both sides of the flexible body.
c) a sticky back residue lifting pad to be approx. 1½″ wide and 5″ long to be placed on the remaining planer body.

2. The device body of claim 1 wherein the body is made from polyethylene plastic or the like and is approx. 1/16″ thick 2″ wide 5″ long.

3. The device body of claim 1 wherein the receiving/scrubbing material be made of, but not limited to a Velcro R type material approx. ½″ wide 5″ long

4. The device body of claim 1 wherein the receiving/scrubbing material is permanently attached to the outer planer edge of both sides of device.

5. The device body of claim 1 wherein the sticky back residue lifting pad is made of cotton/felt or any usable dirt lifting material, which can be peeled off and discarded.
